(19) United States
(12) Patent Application Publication
(10) Pub. No.: US 2016/0260337 A1
(43) Pub. Date: Sep. 8, 2016

(54) Educational system about the generation and consumption of electric energy

(71) Applicant: Helge Carl Nestler, Chattanooga, TN (US)

(72) Inventor: Helge Carl Nestler, Chattanooga, TN (US)

(21) Appl. No.: 15/055,605

(22) Filed: Feb. 28, 2016

Related U.S. Application Data
(62) Division of application No. 29/554,728, filed on Feb. 15, 2016.
(60) Provisional application No. 62/176,818, filed on Mar. 2, 2015.

(51) Int. Cl. G09B 5/00; H05B 37/02

(52) U.S. Cl. CPC G09B 5/00; H05B 37/0209

(57) ABSTRACT

The present invention discloses a portable electric energy teaching aid that can be combined with different energy generation devices. The invention is adapted for students with diverse background knowledge in order to assist the individuals in learning the principles behind electric energy generation and consumption. The energy generated can be conveniently converted and directed to arrays of typical household lamps. The household lamps serve as a meter to indicate the amount of energy consumed. The lamp arrays are arranged in a manner so that the student can directly compare the energy generating capability of each connected energy generation device.

### CROSS REFERENCE TO RELATED APPLICATION

This application claims priority from U.S. Provisional Application Ser. No. 62/176,818 filed Mar. 2, 2015. This application also is related to application Ser. No. 29/554,728 entitled “Energy Generation and Consumption Learning Tool” filed on Feb. 15, 2016.

### FIELD OF THE INVENTION

The object of this present invention is to provide a teaching aid to be used in instruction and experimentation to demonstrate the generation and consumption of electric energy.

More specifically, the present invention relates to a device adapted to assist in teaching students by directly comparing their own capability to generate electricity with their muscles versus the capability of other sources of electric energy like Photovoltaic systems, Fuel cells, wind mills etc. by converting and directing the electric energy to one or more of a plurality of common household light bulbs.

### BACKGROUND OF THE INVENTION

The climate change and the protection of our resources evolved to a high priority issue for humanity. The generation of electric energy from renewable resources and the saving of energy by using e.g. energy saving devices are significant drivers to reduce the CO2 emissions into our atmosphere.

The generation of electric energy is still unknown to the majority of the population. One challenge is how to increase the awareness of the people of the generation and consumption of electric energy and the need for saving energy for our current and future generations.

Today's markets provide a vast variety of renewable energy generation technologies like solar panels or fuel cells and new energy saving devices like LED household lamps in lieu of incandescent lights. The challenge is that it is not fully understood how this works and what impact the technology has on our energy consumption and the protection of our environment.

To impart this knowledge and hence the awareness to a broad audience with diverse educational background, it is important to provide a means of learning that can easily and sustainably deliver the core information of this complex matter to the students. This is generally achieved through hands-on activities and demonstrations together with the student.

However, currently available teaching devices are not adequate for serving as teaching aids because they do not allow a broad audience to understand this topic. The prior art requires certain background knowledge about measuring of energy and the flow of energy and hence provide only abstract dimensions through means of electrical instruments displaying the energy values as a number. This assumes that the students know what the measured values imply. The currently available teaching aids do not provide a combined means of a direct and quantitative comparison of generated energy with the students own physical stamina versus the energy generation capability of diverse means of electric energy generators. The currently available teaching aids do not provide a means of measuring the generated power by means of one or more of a plurality of common household lamps. The currently available teaching aids do not provide a teaching aid that can directly and quantitatively compare different types of common household lamps against each other.

Therefore, there is a need in the prior art for a teaching aid for energy generation and consumption that provides all of the aforementioned benefits.

### BRIEF SUMMARY OF THE INVENTION

In view of the foregoing disadvantages inherent in the known types of teaching aids of the generation and consumption of electric energy now present in the prior art, the present invention provides an electric energy generation and consumption teaching aid wherein the same can be utilized for providing convenience for the user when teaching students with no knowledge or limited knowledge about the subject of energy generation and consumption.

The present device is adapted to serve as a teaching aid that can be combined with a plurality of different energy generation devices and a plurality of typical household lamp as energy consumer, in order to assist individuals in learning the principles behind electric energy generation and consumption.

The present invention comprises a transportable box that contains: electrical receptacles, voltage regulators, electrical manual switches and typical household electrical lamp sockets.

The present invention further includes
1. A number of different common household lamps that can be removably attached to the electrical lamp sockets in making necessary measurements of the energy generated through direct comparison of the number of lamps illuminated by the connected energy sources.
2. A number of energy generating sources that can be electrically connected to the teaching aid through the receptacles.

### BRIEF DESCRIPTION OF THE DRAWINGS

The accompanying drawings illustrate embodiments of the invention and, together with the description, serve to explain the invention. These drawings are offered by way of illustration and not by way of limitation; it is emphasized that the various features of the drawings may not be to-scale.

FIG. 1 Illustrates, in accordance with embodiments of the present invention, a perspective view of the invention.

FIG. 2. Illustrates, in accordance with embodiments of the present invention, the use of the device when attached to a plurality of electric energy generation sources.

FIG. 3 Illustrates, in accordance with embodiments of the present invention, a diagram of the electrical circuits and components that are mounted inside or outside of the invention.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

In one aspect, the device is a box sufficiently large to provide for the support of a sufficient number of common household lamps, while also being of sufficiently small size to be easily portable by hand. In a further aspect, the box also allows for the storage of other components necessary to operate electric circuits in order to illuminate the attached household lamps with the connected electric energy generation sources. The electrical components may include but are not limited to conducting wires, inverters, voltage regulators, standard household lamp sockets and receptacles for the connection to the energy sources. The box and its contents can be easily carried by a single person by means of a handle, strap or other such mechanism attached to the box.

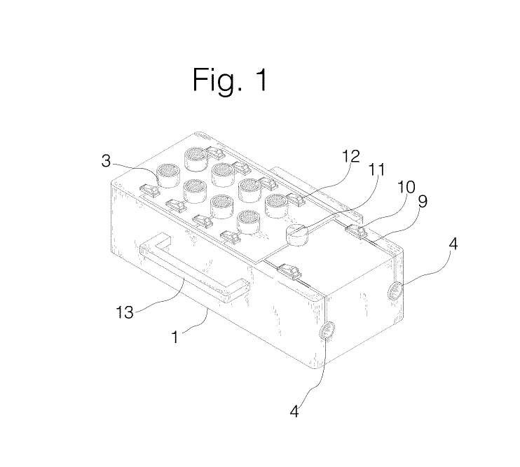

Referring now to FIG. 1, there is shown the invention not assembled. The invention comprises a box 1 with handles 13 that has a plurality of typical household lamp sockets 3 attached to the box 1. The Lamp sockets 3 are arranged in two identical rows that facilitate a direct comparison between the number of lamps that can be attached to the lamp sockets 3 illuminated by the respective connected energy generation source. Each Lamp socket 3 can be discretely activated by manual electrical switches 12 mounted to the box 1. The depicted embodiment of the present invention comprises eight lamp sockets 3 arranged in two discrete rows; however, no claim is made as to the number of lamp sockets 3 and number of rows utilized by the present invention. The invention further comprises a box 1 with electrical receptacles attached to the box 1 to connect external energy sources. The depicted embodiment of the present invention comprises two electrical receptacles 4; however, no claim is made as to the number of electrical receptacles 4 by the present invention. Electrical traces 9 are displayed on the outside of the box to provide a better understanding of the energy flow.

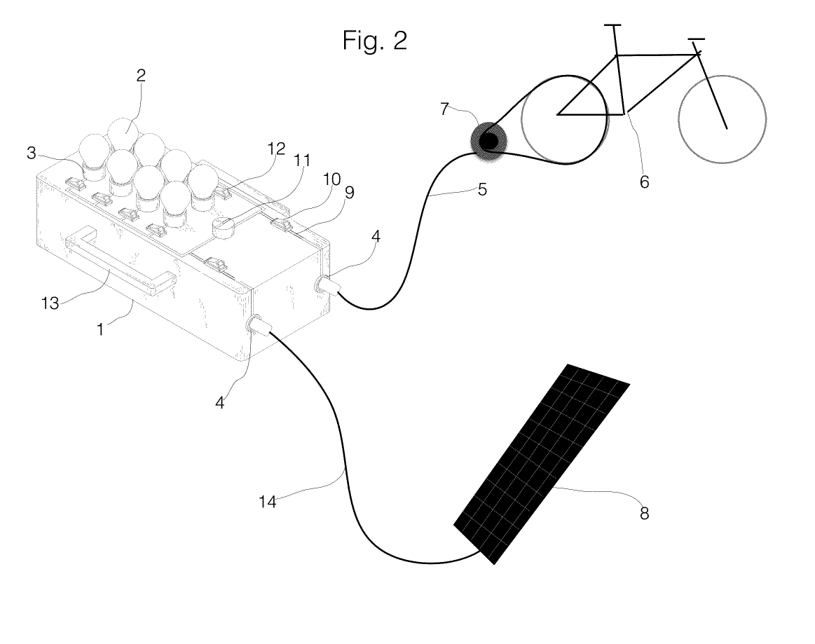

Referring now to FIG. 2, there is shown the use of the invention when attached to diverse electric energy sources and when fully assembled with common household lamps 2. A bicycle 6 mechanically connected to an electrical generator 7 can be electrically connected over a wire 5 to a receptacle 4 of the box 1. The energy generated with the Generator 7, once connected to the box 1, can be directed to the lamps 2 by activating the manual electrical switch 10 and a number of the manual electrical switches 12 depending on the capability of the power source. If desired, the electric energy flow can be directed to further lamps by activating the manual electrical switch 11 or when the user wants to compare different types of light bulbs 2 to each other by having only one energy generation source connected to one receptacle 4 of the teaching aid.

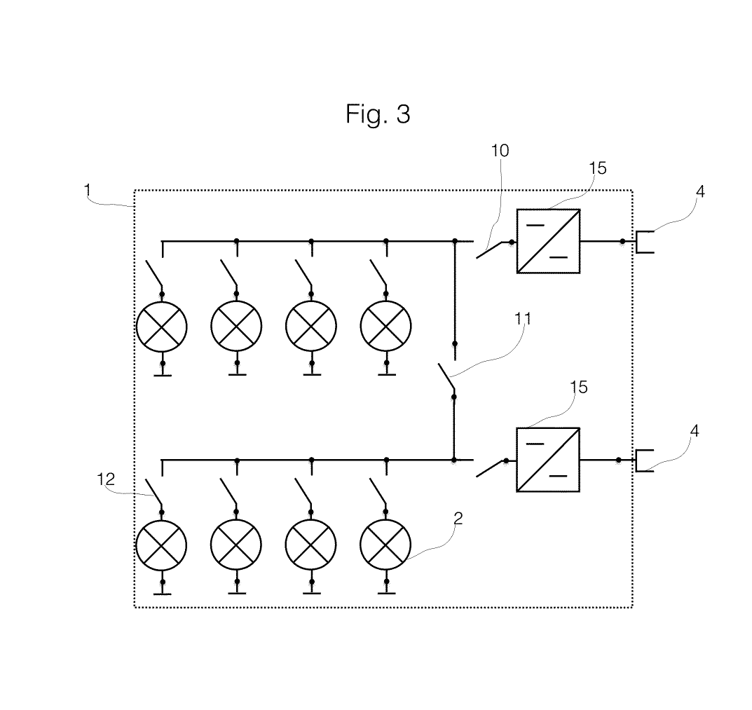

If the user wants to directly compare one energy source with another, one can connect in parallel another energy generating device 8 which is in this case a solar panel with a wire 14 into the receptacle 4. The organization, design and placement of the items on the box is merely illustrative and not limited by the present invention, and variations in the placement, size, and shape of the switches would be readily apparent to those of skill in the art of product design. Referring now to FIG. 3, there is shown a diagram of the electrical circuits and components that are mounted inside and outside of the invention.

The generated electrical energy of each generator 7 or 8 once connected to the receptacles 4 is directed through a voltage regulator 15 to provide a constant regulated voltage rated to operate the the household lamps 2.

Although the foregoing invention and its embodiments have been described in some detail by way of illustration and example for purposes of clarity of understanding, it is readily apparent to those of ordinary skill in the art in light of the teachings of this invention that certain changes and modifications may be made thereto without departing from the spirit or scope of the appended claims. Accordingly, the preceding merely illustrates the principles of the invention. It will be appreciated that those skilled in the art will be able to devise various arrangements, which, although not explicitly described or shown herein, embody the principles of the invention, and are included within its spirit and scope.

I claim:

1. An electric energy teaching aid to be connected to a plurality of different energy source comprising:
a housing; handles attached to the housing to carry the housing by hand;
a plurality of an electric light bulb, as a means to gauge the energy generated by the energy source connected to it, each of which attached to a lamp socket;
a plurality of said lamp socket, each of which is attached to the housing and arranged in a multitude of identical rows, each row has the same number of lamp sockets;
a plurality of an on/off switch, each of which is attached to the housing and electrically connected to said electric light bulbs, as a means to interrupt the electric energy flow to each of said electric light bulb,
a plurality of an electric energy conversion device, each of which attached to the housing and electrically connected to said light bulbs, as a means to convert an unregulated electric voltage and current form of an electric energy source into a constant electric voltage and current form that is rated to feed said electric light bulbs;
a plurality of an electrical receptacle, each of which is attached to the housing and electrically connected to said electric energy conversion device, as a means to electrically connect with a plurality of said electric energy sources.

2. The electric energy teaching aid of claim 1, wherein the electric light bulbs are physically arranged in two rows parallel to each other having equidistant spacing between each lamp socket.

3. The electric energy teaching aid of claim 1, wherein each of said lamp socket row forms a discrete electrical circuit, comprising said plurality of electrical light bulb, said plurality of on/off switch, one of said electric energy conversion device and one receptacle, electrically connected to an electric energy source.

4. The electric energy teaching aid of claim 3, wherein the plurality of said lamp socket that form a row is electrically connected in parallel to each other.

5. The electric energy teaching aid of claim 3, wherein the electric energy flow from each of said electric energy conversion device can be directed to each lamp socket row.

6. The electric energy teaching aid of claim 3, comprising only one said electric energy conversion device, electrically connected to a plurality of said discrete electric circuit, comprising a plurality of said electrical receptacle, a plurality of said lamp socket row, a plurality of said electrical light bulb and a plurality of said on/off switch.

7. The electric energy teaching aid of claim 1, wherein the electrical switches are manually operated electrical switches.

8. The electric energy teaching aid of claim 1, wherein the lamps are household lamps rated no greater than 60V Direct Current.

9. The electric energy teaching aid of claim 8, wherein the electric energy conversion device is a Direct Current-to-Direct Current voltage regulator.

10. The electric energy teaching aid of claim 1, wherein the lamps are household lamps rated greater or equal than 110V Alternating Current.

11. The electric energy teaching aid of claim 10, wherein the electric energy conversion device is a Direct Current-to-Alternating current inverter.

12. The electric energy teaching aid of claim 1, wherein the said household lamps are Incandescent lamps

13. The electric energy teaching aid of claim 1, wherein the said household lamps are Light Emitting Diode lamps.

14. The electric energy teaching aid of claim 1, wherein the said household lamps are Fluorescent light bulbs.

15. The electric energy teaching aid of claim 1, wherein the electrical traces are depicted outside of the housing to facilitate the understanding of the energy flow.
